(19) United States
(12) Patent Application Publication
(10) Pub. No.: US 2026/0001808 A1
(43) Pub. Date: Jan. 1, 2026

(54) MICROMECHANICAL COMB STRUCTURE MADE OF GLASS, AND ASSOCIATED METHOD OF USE

(71) Applicant: LPKF Laser & Electronics SE, Garbsen (DE)

(72) Inventors: Roman Ostholt, Langenhagen (DE); Norbert AMBROSIUS, Garbsen (DE); Maik BERTKE, Hannover (DE); Svenja SCHUDAK, Hannover (DE); Michael LOOTZE, Garbsen (DE); Julia VOSS, Bückeburg (DE)

(73) Assignee: LPKF Laser & Electronics SE, Garbsen (DE)

(21) Appl. No.: 18/880,621

(22) PCT Filed: Jul. 5, 2023
(86) PCT No.: PCT/EP2023/068494

§ 371 Date: Jan. 2, 2025

(30) Foreign Application Priority Data
Jul. 5, 2022 (DE) 10 2022 116 784.4

(51) Int. Cl. C03C 23/00; C03C 15/00; G02B 26/08

(52) U.S. Cl. CPC C03C 23/0025; C03C 15/00; G02B 26/085

(57) ABSTRACT

In order to extend the possible applications of the already known LIDE (laser-induced deep etching) method, this invention provides for producing a micromechanical comb structure (25) by placing a plurality of laser pulses (4) on a glass substrate (3) with a subsequent wet-chemical etching step for exposing the comb structure (25), and to precisely control the position of those laser pulses (4) that define the outer contour (6) of respective fingers (24) of the comb structure (25). This makes it possible to form very narrow fingers (24) that have uniform sidewalls (13), whereby very small gap dimensions (35) and uniform electrostatic actuation of the comb structure (25) are rendered possible. By controlling the phase angle φ and/or the extent of the sidewall scalloping of the fingers (24), it is also possible to favorably influence or set, in a targeted manner, the mechanical properties of the comb structure (25).

### CROSS-REFERENCE TO RELATED APPLICATIONS

This application is a 371 National Phase of PCT/EP2023/068494, filed Jul. 5, 2023, which claims priority from German Patent Application No. 10 2022 116 784.4, filed Jul. 5, 2022, both of which are incorporated herein by reference as if fully set forth.

### TECHNICAL FIELD

The invention relates to a micromechanical comb structure made of glass that has a plurality of micromechanical fingers, wherein the comb structure is deflectable in a substrate plane defined by a glass substrate and wherein the fingers were etched free from the glass substrate by means of laser-induced deep etching (LIDE), i.e. exposed by laser-induced modification of the glass substrate and subsequent wet-chemical anisotropic etching. In other words, the invention thus proposes a monolithic comb structure made of glass that was (completely/overall) defined by means of the LIDE method, wherein the glass comb structure created thus is movable and can therefore be configured as part of a microelectromechanical (MEMS) sensor or actuator.

The invention also relates to a micromechanical actuator (which can be configured as a stepper actuator in particular) based on such a comb structure, and to a method for producing such a comb structure. Finally, the invention also proposes a specific use for such a comb structure.

### BACKGROUND

The LIDE method is already known, for example from the patent document EP 2964417 B1. A frequent use thereof to date lay in etching structures into glass substrates, which for example take the form of a housing for a sensor. The invention considers how the applications of the LIDE method can be broadened. In the LIDE method, a material change (modification) is introduced (optically) into the glass body with the aid of a single laser pulse, typically over an entire thickness of a glass substrate, the modification leading to a subsequent wet-chemical etching step allowing anisotropic etching of the structure in the glass substrate thus optically pretreated/exposed by the laser, even though the etching solution in fact exhibits isotropic etching properties. For example, this technique allows the generation of high-quality through-hole vias in glass, which is of interest for hermetic assembly and interconnection techniques (hermetic packaging).

In this context, pulsed lasers can be used in the LIDE method, wherein the glass is modified along the z-direction (=optical axis/surface normal of the glass substrate) with each laser shot (one laser pulse) in that case. Typically, no change is applied to the utilized beam profile in this case. Thus, in particular, unlike other laser-based (e.g. ablative) glass processing methods, individual small volumes (voxels) within the glass volume are not treated differently by the laser in LIDE methods. Using this already known prior art as a starting point, the problem addressed by the invention is that of broadening possible applications of the LIDE method.

In this context, the invention identified the following: The wet-chemical etching used in the LIDE method always starts at a substrate surface and, from there, advances into the depth (z-direction) of the glass substrate. Depending on the chosen process parameters (glass substrate material, etching solution and temperature used in particular), the etching radius r in this case can reduce to a greater or lesser extent along the z-direction (i.e. normally to the substrate plane) in the xy-plane (=substrate plane), whereby edge profiles that are at an angle to the z-axis are obtainable (for example in the xz-plane). In this case, inclinations that correspond to a decreasing etching radius r at an increasing depth z are always the only possible inclinations. However, the etching radius r on the substrate surface always has the same size since it only depends on the etching solution and the overall etching time; therefore, it cannot be modified in spatially resolved fashion, which represents a central constraint of the LIDE method. The invention has also identified that the free placement of the laser pulses to the substrate surface that is possible here allows very accurate structuring of fingers of a micromechanical comb structure, which thus can take a monolithic form with advantageous micromechanical properties, as will still be explained in detail below.

Hence, optical processing of the glass substrate within the scope of the LIDE method is not ablative, i.e. the desired ablation of material from the glass substrate is obtained only at a later stage during the wet-chemical etching step and not by means of laser radiation. Likewise, the LIDE method can manage without sacrificial layers, and there is no need to invest effort in producing masks as used in conventional photolithography. In other words, the irradiation of the glass substrate by laser to form the aforementioned modification is implemented without masks in the LIDE method.

A further possible characteristic of the LIDE method (that can be exploited according to the invention) is that the actual etching step used to expose the comb structure is implemented in one stage, i.e. in a single wet-chemical etching step. The LIDE method can also manage without thermal annealing, which is required in certain glass types that can be etched anisotropically. All of this leads to a very efficient and hence cost-effective production.

Moreover, the LIDE method can be used to process even more glass substrates, with the aid of which the micromechanical glass comb structure according to the invention can be enclosed. For example, it is thus possible to form a cutout or additional perforation holes in the respective further glass substrate, for instance so that the comb structure is protected against external mechanical influences but remains movable at the same time, and moreover communicates with the outside world via the perforation holes. The respective etching radius r (z) created in different xy-planes at different z-depths of the glass substrate allows the formation of characteristic indentations in the side faces (in the direction of the xz-plane or yz-plane), said characteristic indentations always being concave because the etching solution etches isotropically in a specific xy-plane and consequently forms a convex etching front. This creates protruding glass ribs in these side faces etched free using wet chemistry, said glass ribs protruding between the respective indentations and extending in the z-direction like the indentations. Depending on the chosen process parameters, this may give rise to an inclination of the indentations not only in the y-direction (e.g. for a structure extending in the x-direction) but also in the x-direction (for instance at the tip of such a structure).

Observations have also revealed that the ribs, which should actually have sharp edges purely geometrically, become rounder as the etching duration increases; this appears to be caused by microscale chemical processes. In this case, the ribs/indentations exhibit a spacing Lₓ, which corresponds to the pulse spacing p, to be precise of those laser points that cause the formation of the respective indentation. Since the ribs/indentations appear similar to the ribs on the outside of a scallop shell, these structures can be referred to as sidewall scalloping.

### SUMMARY

Taking account of these aspects, one or more of the features disclosed herein of claim 1 are provided according to the invention on a micromechanical comb structure in order to solve the aforementioned problem.

Thus, in particular, in order to solve the problem, the invention can provide for the application of laser pulses that define an outer contour of the fingers on respective continuous (real or merely imagined) tool trajectories that are opposite each other (and follow the contour), especially straight-line or curvy tool trajectories, preferably at a constant pulse spacing p, in the production of the fingers in the case of a micromechanical comb structure made of glass of the type set forth at the outset. Further, provision is made for each of the tool trajectories to have a maximum distance r from the contour, in particular from concave indentations of the contour, the distance corresponding precisely to an etching radius r of a wet-chemical etching step used to expose the fingers.

To form the movable and monolithic comb structure made of glass (the fingers can either be passively movable, for instance in the case of a sensor, or actively movable in the case of an actuator), it is also possible by means of the LIDE method (i.e. by a laser-induced modification of the glass substrate and subsequent wet-chemical anisotropic etching) to define at least one flexure, by means of which the comb structure, in particular individual fingers of the comb structure, is deflectable and monolithically connected to the glass substrate.

Thus the invention has recognized that the LIDE method opens up completely new possibilities for monolithically forming glass-based high-performance MEMS with desired micromechanical properties. Unlike what was previously often the case, it is therefore no longer necessary to resort to a second substrate made of silicon in which the actual MEMS chip/the actual comb structure is formed; instead, the entire comb structure can be formed monolithically in the glass substrate in a single wet-chemical etching step.

In this case it is preferable, in the process, if all laser pulses that define the outer contour of at least one of the fingers (i.e. also of two of the fingers under certain circumstances) in a certain portion of this finger are located on such a (real or imaginary) tool trajectory (that continuously follows the contour). In this case, each laser pulse is opposite (in a direction perpendicular to the tool trajectory) a respective concave indentation in the sidewall of the finger. Thus, in this case, the contour of the finger on one side of the finger is specified exclusively by laser pulses placed on a single continuous tool trajectory at a distance r from the contour, more precisely at a distance r from the concave indentations in the sidewall of the finger. Accordingly, a characteristic sidewall structure of the finger arises by way of above-described sidewall scalloping. In this case, the respective tool trajectory connects adjacent laser points to one another and thus runs continuously over the laser points that define the contour.

Under certain circumstances, a single laser point can in this case also define the respective contour of two directly adjacent fingers of the comb structure. This is the case should the laser point be placed centrally between the two adjacent fingers. Accordingly, the fingers then have a spacing of D=2r (on the substrate surface) at the location of the laser point.

Such process control in production allows the configuration of particularly slender fingers. This can achieve a high fill factor, measured as total number of fingers/area of the comb structure, which is advantageous in view of obtaining efficient electrical actuation or an efficient sensor system on the basis of the comb structure. For example, a comb structure with such fingers can be used as an electrostatic micro-actuator of a micromechanical linear or rotary drive.

When relatively large cavities or vias are defined in a glass substrate—LIDE is already used for this purpose—the precise application location and density of the laser pulses or the extent to which sidewall scalloping is pronounced is not important as this does not have a significant influence on the structure formed. However, this changes dramatically if the LIDE method is intended to be used in the definition of delicate fingers of a comb actuator, as proposed by the invention. This is because, as will be shown in detail below, the micromechanical properties of the fingers are then influenced significantly (specifically with more or less homogeneous properties) by the relative position of the laser pulses on the two opposite tool trajectories and by the density of the laser pulses on the respective tool trajectory. As mentioned previously, the laser pulses can preferably be placed at a constant pulse spacing p on the respective tool trajectory, at least in sections in any case (for example the application on the respective tool trajectory of at least 3 adjacent laser pulses in succession, at a pulse spacing p). It is understood that the respective tool trajectory may have a minimum distance of r−t_{y} from the contour depending on the chosen extent of sidewall scalloping, where t_{y} is the depth of the respective indentation in the sidewall of the respective finger.

Further, provision can be made for the fingers to form or comprise two opposite sidewalls in each case (that extend transversely to the substrate plane, i.e. in the direction of a surface normal of the substrate plane in particular), said sidewalls exhibiting concave indentations. In this case, these indentations each exhibit a curvature defined by an etching radius r and/or are delimited by respective convex ribs, and/or the indentations and the ribs extend along a surface normal of the substrate plane. In this case, each indentation can be assigned to one of those laser pulses on the associated tool trajectory that define the outer contour of the finger. In this case, directly adjacent aforementioned ribs can have a spacing Lₓ=p, which precisely corresponds to the pulse spacing p of the associated laser points. Said ribs can typically extend in the z-direction, i.e. at right angles to the substrate plane. The same also applies to the extent of the indentations themselves. In this case, both the ribs and the indentations can form an inclination to the z-axis, depending on the chosen degree of anisotropy of the etching process. In this case, each of the indentations can be assigned an associated laser point that was at a distance r from the contour (=outer contour line on the substrate surface/on the top side of the bending structure) or from the indentation.

In such a configuration of the fingers with sidewall scalloping, it is preferable for the indentations—at least in sections, but preferably along an entire length of the respective finger—to exhibit a constant/unchanging mean spacing Lₓ (Lₓ thus is the mean spacing between two directly adjacent aforementioned ribs formed in the same sidewall). This is because the sidewalls can have a regular form in this case; this is advantageous for precise electrostatic actuation.

Furthermore, it is particularly advantageous for the ribs to follow an outer imaginary contour trajectory that extends parallel to a center axis (in the case of a straight finger) or centerline (in the case of a bent finger) of the respective finger. This is because this can minimize a waviness of the contour trajectory, and hence a waviness of the sidewalls of the fingers. If bent fingers are used, the centerline of the finger can preferably extend with a constant curvature; the same then also applies to the associated contour trajectory. By contrast, the contour trajectory can preferably have a straight extent in the case of a straight finger.

Opposing ribs which are formed in opposing sidewalls of a respective aforementioned finger can be formed such that they exhibit an offset Ax along a direction of extent of the finger. Then, the following can preferably apply to this offset: Lₓ/4≤Δx≤Lₓ/2, where Lₓ is the mean spacing between two directly adjacent aforementioned ribs that are formed in the same sidewall. In such a configuration, the width B(x) of the fingers—for a given extent of sidewall scalloping—will only vary to a small extent; this is advantageous in view of achieving high break resistance and great homogeneity of the mechanical properties of the respective finger. Thus, this is a first example as to how the precise relative application of the laser pulses influences the micromechanical properties of the fingers.

Weakly pronounced sidewall scalloping may help with configuring the sidewalls of the fingers to be as smooth as possible. This is because this can avoid complicated postprocessing of the fingers following the wet-chemical exposure, and moreover the variation in the width of the finger along its direction of extent will be smaller, and so the stiffness of the finger is more homogenous. In order to obtain weakly pronounced sidewall scalloping, the laser pulses can be placed in such a way and the fingers etched free in such a way that the following applies to a ratio of a mean pulse spacing p between adjacent laser pulses on one of the two tool trajectories and the etching radius r, preferably along the entire length of the respective finger: p<r, preferably p<r/2, and particularly preferably p<r/3. This is a further example as to how the density of the laser pulses on the respective tool trajectory significantly modifies the micromechanical properties of the fingers.

A further advantage of such a configuration is that the spacing between opposing fingers in the comb structure has comparatively small variations because the side faces exhibit only indentations with a small depth in the event of only weakly pronounced sidewall scalloping, and hence the spacing (gap dimension) between directly adjacent fingers in the comb structure changes only insubstantially (exemplary variation <10%) in the longitudinal direction of the respective finger. This has an advantageous effect on the response behavior of the comb structure. Moreover, homogeneous electric scattering fields can be obtained, and hence a uniform development of force can be ensured during an electrostatic actuation of the comb structure. Thus, a uniform sensor characteristic (i.e. a uniformly generated charge shift as a consequence of the deflection of the fingers) arises in sensor-type applications.

In general and especially in such configurations, it is moreover preferable for directly adjacent aforementioned laser points (=laser pulses) to have a minimum pulse spacing of at least 3 μm or even at least 5 μm. This is because this renders optical shadowing effects avoidable and homogeneous etching results obtainable, ensuring that the extent of sidewall scalloping can be set in reproducible and targeted fashion.

For example, the following may apply to a ratio of the local etching radius r and a lateral depth t_{y} of the respective indentations: t_{y}/r<0.1, preferably t_{y}/r<0.05.

In addition or in an alternative to such features, the following may apply to the ratio of maximal width B of the respective finger transversely to its direction of extent and the lateral depth t_{y}:t_{y}/B≤0.1, in particular t_{y}/B≤0.05. Such parameters of the comb structure also result in particularly efficient electrical actuation or a particularly efficient electrical sensor system on the basis of the comb structure because the micromechanical properties of the fingers improve as a result: Hence, such a configuration proposes particularly flat/little pronounced sidewall scalloping, whereby a particularly small variation in the width of the bending structure and hence a great homogeneity of the stiffness are achieved. Such a configuration may be advantageous, for instance to enable a particularly high break resistance and hence particularly large deflections of the bending structure. By contrast, the sensitivity with which the bending structure can detect mechanical vibrations can be increased in sensor-based applications.

Particularly weak sidewall scalloping will be accompanied by advantages as regards the homogeneity of the mechanical properties of the comb structure, especially when the width of the fingers is comparatively small, as this accordingly leads to a correspondingly large ratio of t_{y}/B and moreover a high energy density of the electrostatic actuation/sensor system.

As yet to be explained in detail below, the fingers in the comb structure can also be exposed by two-sided wet-chemical etching, i.e. by etching from two opposite surfaces of the glass substrate. Therefore, the fingers may in particular exhibit a rhombic cross section that results from wet-chemical etching of the glass substrate on both sides. In such a configuration, a maximum width Bₘₐₓ of the fingers can be located at a distance from a surface of the glass substrate, for instance in a central plane of the glass substrate, for instance if etching is performed simultaneously (and at the same speed) from both sides.

Depending on the material chosen for the glass substrate and on other process parameters of the etching step that also influence the anisotropy of the etching, side faces of the fingers may each form a respective taper angle φ with a surface normal of the glass substrate. In this case, the taper angle is preferably less than 6°, and by preference less than 3°, for a high fill factor and efficient actuation.

A further process parameter lies in the choice of the pulse spacing in relation to the width of the individual finger. In this case, the following may apply to a ratio of a pulse spacing p, in particular a minimal or maximal pulse spacing, between two adjacent laser pulses or laser points on a tool trajectory extending parallel to the respective contour of the respective finger and a maximum width B of the respective finger as measured transversely to its direction of extent: p/B<0.5, preferably p/B<0.3, or even p/B<0.2.

For example, the maximum width B of the respective finger in the comb structure can be less than 100 μm, in particular less than 50 μm.

Further, a gap dimension between two directly adjacent fingers in the comb structure can be less than 50 μm, in particular less than 30 μm.

To enable electrostatic actuation, sidewalls of the fingers may comprise a metallization that serves the formation of electrodes. Such electrodes can be used to realize an electrostatic actuation or a capacitive sensor system with the aid of the comb structure.

According to a further advantageous configuration, provision can be made for a respective spatial phase angle q (x) of respective laser pulse pairs/laser point pairs or opposing ribs in sidewalls of one of the fingers along a respective direction of extent of the (respective) finger to be chosen such that in a specific actuation position of the comb structure, ribs formed in sidewalls of the finger are formed flush on one side with corresponding ribs of a first directly adjacent finger and with an offset to corresponding ribs of a second directly adjacent finger on an opposite side. In this case, opposing ribs of the finger located between the first and second directly adjacent fingers may exhibit an offset Δx<Lₓ/4, in particular Δx=0.

It is understood that in respect of all the aforementioned features, every finger in the comb structure can preferably be formed in the manner described for a single finger.

In the extreme case, in the event of semicircular indentations, the following may apply to the length Lₓ of an indentation: Lₓ=p=2r. Thus, a ratio of p=2r would be chosen in this case, and the sidewall scalloping would be maximally pronounced. Now, the invention has recognized that although this leads to very significant waviness of the sidewalls of the respective finger, this waviness can be exploited, especially in the event of electrostatic actuation, in order to realize a micromechanical stepper motor or a stepper actuator with a very small and precise increment. The invention therefore proposes a micromechanical stepper actuator that is based on a comb structure made of glass with a plurality of fingers that were etched free from a glass substrate by means of laser-induced deep etching (LIDE), i.e. exposed by laser-induced modification of the glass substrate and subsequent wet-chemical anisotropic etching. In particular, the configuration of this comb structure may be as described above. Furthermore, the stepper actuator can preferably be electrostatically actuatable (for example by means of sidewall electrodes formed on the fingers).

Now, the stepper actuator is distinguished in that a step size G of the stepper actuator corresponds to a spacing Lₓ of convex ribs 9 (Lₓ=G) which delimit lateral concave indentations 8 that are formed in sidewalls of the fingers and exhibit a curvature defined by an etching radius r.

In order now to enable a nonlinear response of the stepper actuator, provision can in particular be made for the following to apply to a ratio of the etching radius r and a lateral depth t_{y} of the respective indentations: t_{y}/r>0.1, preferably t_{y}/r>0.2, or even t_{y}/r>0.3. Further, in addition or in an alternative to these features, provision can be made for the following to apply to a ratio of the spacing Lₓ (which still equals the step size G) and the etching radius r: Lₓ/r>0.5, preferably Lₓ/r>0.7.

Such a design of the comb structure results in strongly pronounced sidewall scalloping and hence in an inhomogeneous force characteristic of the stepper actuator that is desired for a step drive. In the case of appropriate dimensioning of the indentations, this can specify a reproducible step dimension in the order of a few μm, with the step dimension being definable by the geometry of the comb structure defined by the LIDE method. In this case, the extent to which the sidewall scalloping is pronounced determines the extent to which the force characteristic deviates from a linear characteristic: the deeper and more pronounced the concave indentations, the more step-like the force characteristic.

For example, such a stepper actuator based on a glass comb actuator manufactured by LIDE can be used for the positioning of an optical component (stop, lens, mirror, etc.) or a mechanical component (i.e. as a micro-positioning device). In particular, this concept represents a simplification over already known “inchworm” actuators based on silicon technology, which require a plurality of actuation electrodes, in particular clutch electrodes, in order to realize a step drive. Moreover, the use of the LIDE method offers cost advantages, especially if long actuator travels over several mm or even cm are intended to be obtained because microstructures having such length dimensions can be manufactured cost-effectively by means of LIDE.

In a stepper actuator of the type described above, provision can further be made for a respective phase angle φ(x) of respective laser point pairs or lateral indentations (11) along a respective direction of extent of directly adjacent fingers of the comb structure to be φ=0°+/−60°, preferably φ=0°+/−30°, in particular φ=0°+/−5°. For example, what can be achieved in such a configuration is that in a specific actuation position of the comb structure, the ribs formed in opposing sidewalls of in each case two directly adjacent fingers are at least approximately flush with one another, preferably even completely flush with one another, to be precise by preference on both sides of the respective finger.

However, further micromechanical actuators can also be formed using the above-described micromechanical comb structures, for instance linear drives or rotary drives. Accordingly, the invention also proposes a micromechanical actuator that comprises a comb structure according to the invention as described above. In this case, the fingers of the comb structure may comprise sidewall electrodes for electrostatic actuation of the comb structure. Further, it is also possible to use comb structures according to the invention as a movable capacitive sensor element in a capacitive sensor.

To solve the problem mentioned at the outset, a method for producing a micromechanical comb structure made of glass is also proposed, wherein the comb structure can be configured with features as explained above (by using the method). Accordingly, the comb structure has a plurality of micromechanical fingers, wherein the comb structure is deflectable in a substrate plane defined by a glass substrate and wherein the fingers are etched free from the glass substrate by means of laser-induced deep etching (LIDE), i.e. exposed by laser-induced modification of the glass substrate and subsequent wet-chemical anisotropic etching. The method is further characterized in that in order to expose the fingers, laser pulses that are intended to define an outer contour of the fingers are placed on respective continuous tool trajectories that are opposite each other, especially straight-line or curvy tool trajectories, preferably at a constant pulse spacing p, and in that all fingers of the comb structure are subsequently exposed in a common wet-chemical etching step such that a respective outer contour of the fingers (i.e. of the respective finger) has a maximum distance r from the associated tool trajectory that corresponds to an etching radius r of the etching step.

Hence, in order to produce the comb structure, laser points can be placed on respective laser lines that have a respective spacing r from a contour of the respective finger r, the spacing corresponding to an etching radius r of a wet-chemical etching step. To manufacture the comb structure, provision can be made, for example within the scope of the LIDE method, for the application of a number of laser points on a laser line in order to introduce a modification into the glass substrate with the aid of laser radiation. Regions of the glass substrate modified thus by means of the laser radiation can then be etched free in the subsequent wet-chemical etching step. In this case, the fingers in the comb structure preferably have microscopic dimensions, for instance in relation to a width (in the substrate plane) and/or height (normal to the substrate plane) of the bending structure. For example, the width/height can be in the sub-mm range and for instance be less than 100 μm, in particular less than 50 μm. By contrast, the length of the fingers can range from the sub-mm to the cm range.

In this method, an anisotropy of the etching step can be chosen such that the fingers are formed with a taper angle φ of no more than 6°, preferably of no more than 3°, with respect to a surface normal of the substrate plane. In this case, it is preferable for a ratio of a first etching rate of regions of the glass substrate modified by means of laser radiation and a second etching rate of unmodified regions of the glass substrate to be chosen to be greater than 15:1, preferably greater than 20:1.

Hence the taper angle describes the inclination the respective sidewall of the finger forms with respect to the surface normal (z-axis) of the (xy-)substrate plane.

The anisotropy of the wet-chemical etching, i.e. the ratio of the etching rates of the regions modified by means of laser radiation and of the regions of the glass substrate left unmodified can be set by way of the etching chemistry. For example, hydrofluoric acid or alkalis such as KOH or NaOH can be used to obtain etching of the non-modified regions that is as slow as possible, and hence great anisotropy. Moreover, use can be made of slowly etching glass types such as Borofloat glass or fused silica.

In this method, the fingers can also be exposed with a rhombic cross-sectional shape by virtue of a wet-chemical etching solution being used to perform etching from two sides of the glass substrate. This can be advantageous to obtain a large aspect ratio of the fingers (the aspect ratio (=height/width of the fingers) can for example be more than 10:1 or even more than 50:1), which offers advantages for both actuator systems and sensor systems. For example, the anisotropy of the etching step can be set in this case such that following the etching, the fingers form an interior angle with a respective sidewall of at least 170°. For simplified process control, it is also preferable for the same wet-chemical etching solution, preferably and approximately the same process parameters such as concentration and/or temperature of the etching solution, to be used in each case to etch both sides of the glass substrate. Hence, the two-sided etching can be undertaken in a single etching step.

In the case of vertical etching (only obtainable approximately by wet chemistry on account of the etching solution etching the untreated glass isotopically), the sidewalls would extend perpendicularly and thus exhibit an interior angle of 180°. It is also understood that to define the modified regions in the glass substrate that are intended to be etched free by wet chemistry, laser pulses can also be placed from both sides of the glass substrate, i.e. on both opposing surfaces of the glass substrate.

In order to obtain weakly pronounced sidewall scalloping in the method, provision can be made for the laser points to be placed in such a way and the fingers to be etched free in such a way that the following applies to a ratio of a mean pulse spacing p between adjacently placed laser points and an etching radius r, preferably along an entire length of the respective finger: p<r, preferably p<r/2.

As mentioned previously, a respective contour of the fingers may exhibit lateral concave indentations as a consequence of wet-chemical etching, said indentations each exhibiting a curvature defined by an etching radius r at a surface of the glass substrate and being delimited by respective convex ribs. Accordingly, process control of the method can also be designed such that the following applies to a ratio of the local etching radius r and a lateral depth t_{y} of the respective indentations: t_{y}/r<0.1, preferably t_{y}/r<0.05. Further, in addition to that or as a supplement, the following can apply to the ratio of maximal width B of the respective finger transversely to its direction of extent and the lateral depth t_{y}:t_{y}/B≤0.1, in particular t_{y}/B≤0.05.

The method can also comprise the application of a metallization. Hence, a metallization serving to form electrodes of the fingers (24) can be applied using a shadow mask or a spray photoresist or a dry photoresist that can be laminated, in each case as a masking layer, on sidewalls of the fingers. The metallization can preferably be deposited on the sidewalls by means of physical vapor deposition (PVD), in particular by means of sputtering.

Finally, the invention also proposes a specific use of a micromechanical comb structure made of glass in a portable electronic device. According to the invention, this comb structure can also be produced and/or configured as described above. This use provides for the comb structure to be part of an electrostatic actuator and/or part of a capacitive sensor and for said comb structure to be used to exert or maintain an electrostatic holding force in energy-saving fashion. In this case, the fingers of the comb structure can have a respective length of >500 μm, in particular greater than 1 mm.

As a result of forming long fingers with only weakly pronounced sidewall scalloping, it is possible to obtain an electrostatic arrangement (interdigital structure/comb structure) that enables a quasi-static actuation—with only minimal power consumption (on account of very low leakage currents)—and hence the exertion of comparatively large (microscopic) holding forces with the aid of a voltage. Unlike the case of an electromagnetic actuation, for example, this makes it possible to avoid relatively large operating currents for maintaining the holding force. This is useful for energy-saving sensor systems and actuator systems and can offer advantages especially in a portable (energy self-sufficient) device.

In the event of a quasi-static actuation, too, minimal sidewall scalloping moreover appears advantageous in order to increase the break resistance of micromechanical springs (that can be formed as described herein), in particular torsion springs, which are used in the actuator system. Quasi-static actuation is moreover of great interest in micromirrors in particular, for example for application in a 3-D tracker system. Consequently, these are also applications in which comb structures according to the invention can be used.

### BRIEF DESCRIPTION OF THE DRAWINGS

The invention will now be described in more detail on the basis of exemplary embodiments, but is not restricted to these exemplary embodiments. Further developments of the invention can be obtained from the following description of a preferred exemplary embodiment in conjunction with the general description, the claims, and the drawings. In the following description of various embodiments of the invention, elements that correspond in terms of their function are denoted by corresponding reference numerals, even in the case of a deviating design or shape.

In the figures

FIG. 1 shows a first (schematic) example of a finger configured according to the invention and found in a micromechanical comb actuator in glass,

FIG. 2 shows a further example of a finger of a micromechanical comb actuator according to the invention in glass,

FIG. 3 shows a further example of a finger of a micromechanical comb actuator according to the invention in glass,

FIG. 4 shows a detailed and schematic view of the outer contour of a portion of a finger of a micromechanical comb actuator according to the invention,

FIG. 5 shows a graph which plots the width B(x) of a finger of the comb actuator as a function of the x-position for three cases of differently designed phase angles φ(x),

FIG. 6 shows a further schematic illustration of a portion of a finger of a comb actuator according to the invention,

FIG. 7 shows a portion of a micromechanical spring element shown in full in FIGS. 14 and 16,

FIG. 8 shows a further schematic top view similar to FIGS. 1-3 of a single finger of a comb actuator according to the invention, with numerous design and/or process parameters being illustrated,

FIG. 9 shows a scanning electron microscope (SEM) recording of a micromechanical comb structure according to the invention, having numerous fingers configured according to the invention, and

FIG. 10 shows a scanning electron microscope (SEM) recording of a single finger of a micromechanical comb structure according to the invention,

FIG. 11 shows a cross-sectional view of a finger of a comb structure according to the invention with a middling taper angle,

FIG. 12 shows a cross-sectional view of a finger of a comb structure according to the invention with a larger taper angle,

FIG. 13 shows a further cross-sectional view of a finger of a comb structure according to the invention with a very small taper angle,

FIG. 14 shows a plan view of a micromechanical comb structure according to the invention which was exposed from a glass substrate by means of the LIDE method,

FIG. 15 shows a metallization (the opening of the shadow mask used is shown) which corresponds to the comb structure of FIG. 14 and which is applied to the comb structure,

FIG. 16 shows an electrostatic rotary drive realized by means of the micromechanical comb structure from FIG. 14 and capable of rotating an end piece that is rotatably suspended from a micromechanical spring element,

FIG. 17 and FIG. 18 illustrate how sidewall scalloping on fingers of the comb structure can be set in a targeted manner in order to enable uniform actuation, and

FIG. 19 shows basic options for placing laser pulses in order to produce a comb structure.

### DETAILED DESCRIPTION

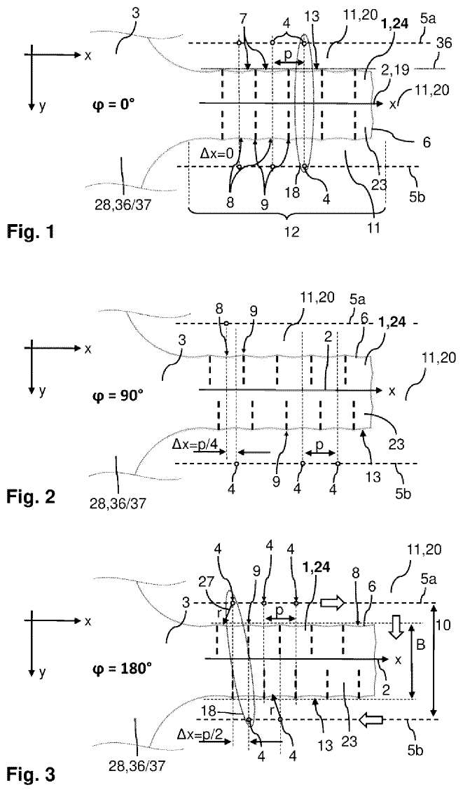

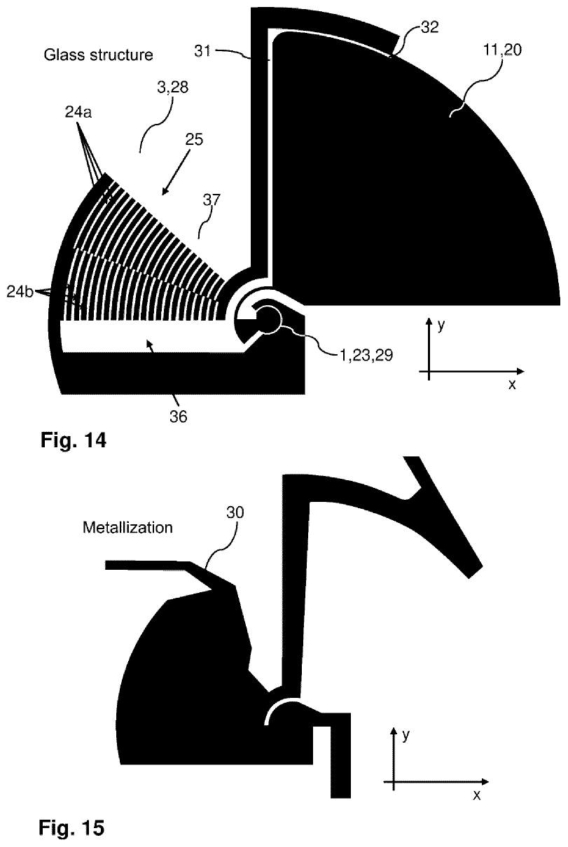

FIG. 1 schematically shows a micromechanical microstructure 1 that was exposed with the aid of the LIDE (laser-induced deep etching) method, said micromechanical microstructure being in the form of a finger 24 that was exposed from a glass substrate 3 in the form of a glass wafer by means of wet-chemical etching. In this case, the view of FIG. 1 is a view from above on the xy-plane of the glass substrate 3 which has a certain substrate thickness t_{glass} in the z-direction. It is evident that the finger 24 is connected on one side to a relatively large anchoring structure that is part of the glass substrate 3. Relative to the glass substrate 3, this anchor 36/37 can be static or else movably mounted, for example by means of a micromechanical spring element 29 (cf. FIG. 14). In the latter case, the finger 24 can thus be deflectable in the xy-plane, for example with a linear movement or a rotational movement.

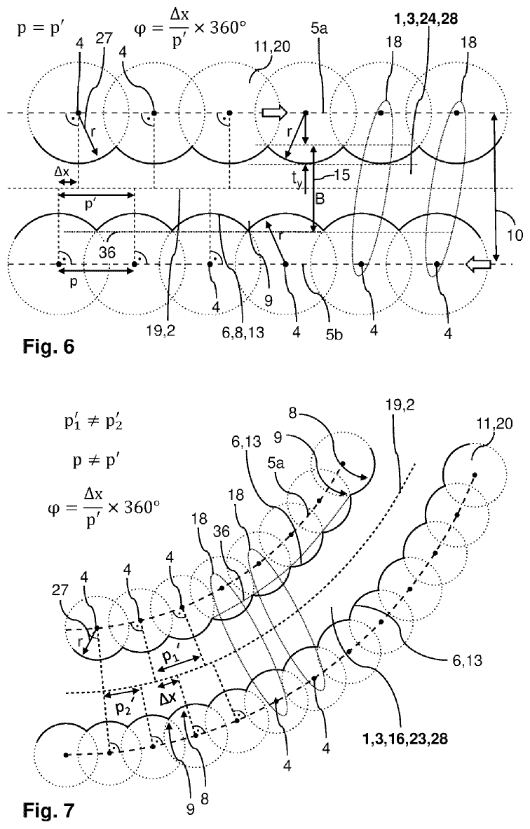

Fine glass pieces can be cut out of or exposed from a glass substrate 3 by means of the LIDE (laser-induced deep etching) method. To this end, a contour 6 is initially traversed by means of a laser, said contour describing the outer boundary of the microstructure 1 to be exposed, for instance the outer boundary of the finger 24 from FIG. 1. To this end, it is proposed to displace a laser head, which emits a pulsed laser beam, along an associated tool trajectory 5a, 5b that follows the contour 6 at a certain distance (cf. FIG. 3). However, since the laser is pulsed, the glass substrate 3 is not illuminated continuously by the laser beam; instead, individual laser pulses 4 are placed as laser points 4 at certain xy-coordinates on the surface of the glass substrate 3. In this case, the laser points 4 can have a constant geometric pulse spacing p (measured in μm in the substrate plane) and/or can all be located on said tool trajectory 5a, 5b. In this case, the block arrows in FIG. 3 are intended to specify the sequence in which the tool trajectories 5 are traversed and the laser points 4 are placed (cf. also FIG. 6).

For example, should an elongate slot be made in the glass substrate 3, a certain total number of laser pulses 4 are placed along a tool trajectory 5, in each case with a pulse spacing p, wherein each laser pulse 5 typically modifies the glass substrate 3 over the entire thickness. In the subsequent wet-chemical etching process, the etching solution eats into the substrate 3 in the z-direction from the surface, with the etching speed in the xy-plane being isotropic such that a circular disk-shaped etching profile 7 with rotational symmetry around a respective laser point 4 is formed on the surface (cf. the circles in FIGS. 4 and 6 to 8). The consequence thereof is that the final exposed contour 6 of the microstructure 1 exhibits a distance r (=etching radius 27) from the center of the original laser point 4 (cf. FIG. 3 or FIG. 6). Expressed differently, at the surface of the glass substrate 3, the exposed contour line 6 of the finger 24 in FIG. 1 exhibits a maximal distance r to the tool trajectory 5 (projected onto the substrate plane), on which the laser pulses 4 were placed.

On account of the etching radii r, concave indentations 8 arise in the respective sidewall 13 of the fingers 24 in the process (cf. FIGS. 1-3), said indentations each exhibiting a curvature defined by the etching radius r 27 and being delimited by respective convex ribs 9, with these ribs 9, and also the indentations 8, extending in the z-direction (cf. FIGS. 1-3 and 4, 6 and 11-13). These structures arising during the wet-chemical exposure of the fingers 24 in the respective sidewall 13 are referred to as sidewall scalloping since the indentations 8 or the interposed ribs 9 form a structure similar to that on the inner side of a scallop shell.

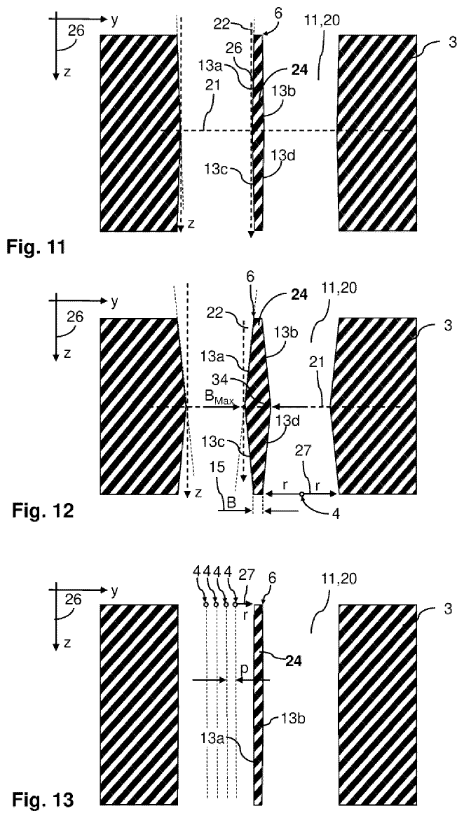

Depending on the chosen process parameters, and hence the degree of anisotropy of the wet-chemical etching, the etching radius 27 r can reduce to a greater or lesser extent in the z-direction (i.e. normally to the substrate plane) in the xy-plane, whereby extents of the sidewalls 13 of the fingers 24 (for example in the xz-plane) that have an inclination or form a taper angle 22 ϕ with respect to the z-axis are obtainable, as illustrated in FIGS. 11-13. Hence, there is a taper angle even in the case of FIG. 12, to be precise over the entire height of the finger 24 in that case, although said taper angle is pronounced only very weakly. However, starting from each laser point 4, the etching radius 27 r always has the same size on the substrate surface. Furthermore, inclinations that correspond to a decreasing etching radius 27 r at an increasing depth z are always the only possible inclinations. This arises from the fact that the wet-chemical etching always starts on the substrate surface and advances into the substrate depth from there. However, it is possible to start this process either from one side (FIG. 13) or else on both sides (cf. FIGS. 11 and 12) from both substrate surfaces such that correspondingly symmetric inclinations arise in the latter case, said inclinations in each case tapering to a centrally (in the z-direction) arranged plane 21 (located parallel to the xy-plane) (cf. FIG. 12).

FIG. 12, which shows a cross section through a finger 24 of a comb actuator 25 according to the invention (with the direction of extent 2 of the microstructure 1/finger 24 extending in the direction of view onto the drawing), indicates that a single laser point 4 may already be sufficient to define a slot of width 2r between one finger 24 and an adjacent finger 24 or the bulk of the glass substrate 3, with the etching solution then forming an etching radius 27 r on both sides on the surface of the glass substrate 3 starting from the laser point 4 (for example in the positive and negative y-direction as in FIG. 12). In that case, the maximum width B 15 of the respective finger 24 measured on the surface of the glass substrate 3 (and measured transversely to the direction of extent 2, i.e. in the y-direction in FIG. 12) may deviate significantly from the maximum width B_{Max} which the finger 24 exhibits in the illustrated central plane 21 of the substrate 3, depending on the taper angle ϕ 22 chosen (cf. FIG. 12).

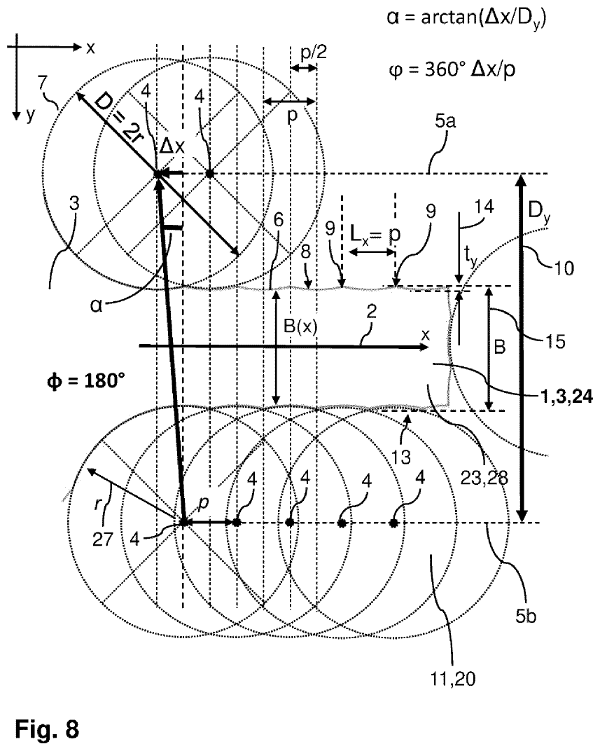

As illustrated by FIG. 12, it is however also possible to apply laser points 4 next to one another with a very tight pulse spacing p such that the resultant etching radii r overlap in that case (cf. also FIG. 8 in this respect). If the anisotropy of the laser-induced wet-chemical etching is chosen to be very large, it is possible to define virtually perpendicular sidewalls 13 of the fingers 24 of the comb structure 25, as shown in FIG. 13 (the taper angle 22 is very weakly pronounced therein).

FIG. 8 illustrates in detail how the finger 24 of FIG. 3 was manufactured. As evident from the circles, which each illustrate the circular disk-shaped etching profile 7 with the edging diameter D=2r, a large number of laser pulses 4 were placed on two opposing tool trajectories 5a and 5b. Since the etching front 7 propagates isotropically in the xy-substrate plane, the laser pulses 4 each have a distance r from the final outer contour 6 of the finger 24, which corresponds precisely to the etching radius 27 r of the wet-chemical etching step used to expose the finger 24. As shown in FIG. 3, two laser pulses 4 located on opposing tool trajectories 5a and 5b can be combined to form a respective laser pulse pair 18. As shown in FIGS. 1-3 and 8, the two laser pulses 4 of a respective laser pulse pair 18 may exhibit an offset—in relation to the direction of extent 2 of the finger 24, corresponding to the x-axis in these Figures—Δx of for example possibly between Δx=0 and Δx=p/2 when a constant pulse spacing p is used.

Depending on the extent of this offset Δx there is a spatial phase angle φ(x) or a spatial phase offset φ(x) between the respective laser points 4 of a laser point pair 18. In the example of FIG. 1, the offset is Δx=0, and hence the laser points 4 of the respective laser point pair 18 are arranged precisely in phase (φ=0°) there in relation to the direction of extent 2. By contrast, the phase difference is maximal (φ=) 180° in the example of FIG. 3 since the offset Δx there is Δx=p/2, where p is the pulse spacing, i.e. the distance between two directly adjacent laser points placed on the same tool trajectory (e.g. 5b)—cf. FIG. 8 in this respect.

By contrast, the ratio p/r of pulse spacing p and etching radius 27 r determines how pronounced the indentations 8 of the sidewall scalloping are. The distance between the ribs 9 along the x-axis Lₓ precisely corresponds to the pulse spacing Lₓ=p−cf. FIG. 8. Moreover, a lateral depth t_{y} 14 can be determined for each indentation 9, to be precise measured transversely to the direction of extent 2, i.e. in the y-direction in FIG. 8.

FIG. 8 moreover illustrates that the two tool trajectories 5a and 5b have a spacing Dy 10. This spacing and the chosen offset Δx determine the step angle α in this case, which is formed by two laser points 4 of a respective laser point pair 18 in relation to the direction of extent 2, where the following applies: α=arctan(Δx/Dy). By contrast, the spatial phase angle φ(x) is determined as φ=360° Δx/p, where the offset Δx can vary depending on the x-coordinate of the laser pulse pair 18, and so the phase angle φ(x) can in principle also vary along the direction of extent 2.

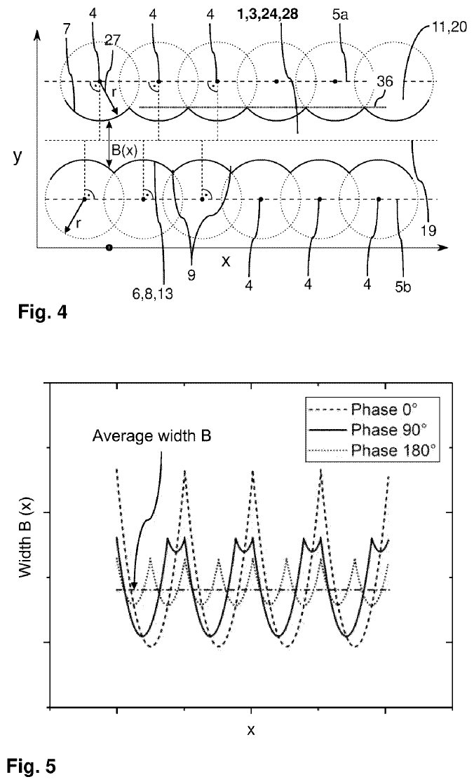

FIGS. 4 and 6 illustrate how the extent of sidewall scalloping, which for example can be read from the ratio t_{y}/r, affects the homogeneity of the width B(x) of the finger 24 and hence also the mechanical properties. In this case, the three curves of the graph in FIG. 5 illustrate how the width B(x) changes with the x-coordinate in the direction of extent 2 (and in this case adopts a maximum width B 15 at respective different x-positions), to be precise for the three cases of a phase angle of 0°/90°/180°, which were illustrated in FIGS. 1-3. As shown by the horizontal dashed line in FIG. 5, three fingers 24 were compared in this case, each finger having the same average width B. The extent of sidewall scalloping (measured in t_{y}/r) was also chosen to be the same. From the graph of FIG. 5, it is evident that the variation in the width B(x) is greatest in the case of a spatial phase of φ=0°.

By contrast, the finger 24 exhibits the smallest variation in the width B(x) in the case of a spatial phase angle of φ=180°. Thus a phase angle of φ=180° not only yields advantages in terms of a higher break resistance; additionally, the spring constant of a microstructure 1 produced in this way can be reduced significantly given the same average width B since the spring constant (for deflections of the microstructure in the substrate plane) has a cubic dependence on the width B. For example, this was applied in the micromechanical spring element 29 shown in FIG. 7, which is part of the electrostatic actuator 33 (based on a comb structure 25 according to the invention) that is shown in FIG. 14. In the case of a phase angle of φ=0°, the local spring constant would vary significantly, by contrast, since the variations of the spring width B are proportional to the third power, whereby this might create peaks in the mechanical stress that could cause a break in the spring 29.

A micromechanical finger 24 made of glass, as illustrated in FIG. 3, which exhibits a phase angle φ(x) of 180° and comparatively weakly pronounced sidewall scalloping therefore is ideally suited to use as part of a micromechanical actuator 33 or sensor since this microstructure 1 is break resistant on the one hand and moreover has homogeneous mechanical properties. In particular, high-quality electrostatic actuation/a high-quality electrostatic sensor system can be realized using such a microstructure 1 on account of these properties.

However, even a phase angle of φ=0°, for example, as shown in FIG. 1, can yield interesting mechanical properties that can be gainfully used from a technical point of view in a comb actuator 33, especially in the precise case of strongly pronounced sidewall scalloping. For example, a great variation in the width B of the finger 24 (as illustrated for the case φ=0° in FIG. 5) may lead to a strong nonlinear response of the associated comb structure 25/associated actuator 33, which can be exploited in a stepper motor/stepper actuator, for example.

As quite evident from FIGS. 1-3, the respective spatial phase angle φ(x) of the respective laser pulse pairs 18 is however set homogeneously in the direction of extent 2 of the finger 24, with the phase angle being φ=0° in FIG. 1, =90° in FIGS. 2 and φ=180° in FIG. 3. On account of the respective straight profile of the finger 24, the phase angle φ(x) in this case only varies within the scope of the accuracy with which the laser points 4 can be placed on the glass substrate 3.

As illustrated in FIG. 6, the effective pulse spacing p′=p in the event of a straight profile of the finger 24 precisely corresponds to the geometric pulse spacing p between two directly adjacent laser points 4 on a tool trajectory 5.

FIG. 7 shows an example of a spring element 29 configured according to the invention, which can be used together with a comb structure 25 according to the invention, in particular in order to mount a movable anchor 36 of the comb structure 25 (which supports some of the fingers 24) in deflectable fashion (i.e., for example, rotatable as in FIG. 14) or else in linearly displaceable fashion in the substrate plane 28. The spring element 29 exhibits a curvy profile 2, as is quite evident on the basis of the centerline 19. Respective laser point pairs 18 can also be considered in such a configuration. However, as illustrated in FIG. 7, the effective pulse spacing p′≠p may deviate from the geometric pulse spacing p. Nevertheless, the respective spatial phase angle φ can be set homogeneously, even for such a profile of the microstructure 1. In the example in FIG. 7, the phase angle varies slightly (by approx. +/−30°) about a mean phase angle of approx. φ=180°, at least in sections.

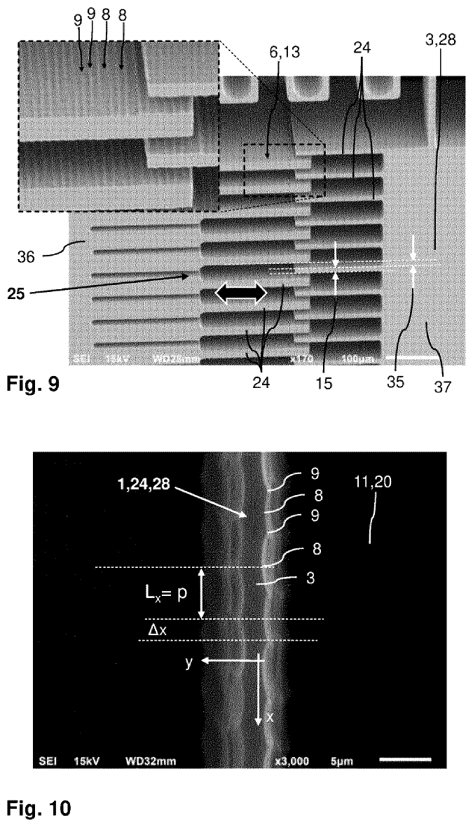

FIGS. 9 and 10 each show, in an oblique view from above, a scanning electron microscope (SEM) recording of a micromechanical comb structure 25 according to the invention (FIG. 9) and, respectively, a single finger 24 (FIG. 10) of such a comb structure 25. The indentations 8 and the interposed ribs 9, which each extend in the z-direction, i.e. transversely to the substrate plane 28, are quite visible, especially in the detailed view of FIG. 9 but also in FIG. 10. In the finger 24 of FIG. 10, the indentations 8/ribs 9 are each formed with a homogeneously set phase angle of approx. φ=150°. The left fingers 24 in the comb structure 25 of FIG. 9 are in this case movable in their respective longitudinal direction (=direction of extent 2) since these fingers 24 are arranged on a movably mounted anchor 36. Consequently, the left fingers 24 can move to a greater or lesser extent into the interspaces (cf. the block arrow) formed between the right fingers 24, which are arranged on a static anchor 37.

FIG. 14 shows an example of how a comb structure 25 according to the invention can be exposed in a glass substrate 3 by means of the LIDE process. In this case, the black areas denote the regions of the glass substrate 3 that were modified by means of the laser and subsequently etched free in an etching step. By contrast, the bright structures mark the glass structures that remained standing following the etching.

In order to be able to electrostatically actuate the comb structure 25, a sidewall metallization 30 is applied to the comb structure 25, more precisely to the sidewalls 13 of the fingers 24, using a shadow mask that was likewise manufactured by means of the LIDE method. In this case, the black regions in FIG. 15 illustrate the opening of the shadow mask, and hence the regions of the glass substrate 3 that are metallized.

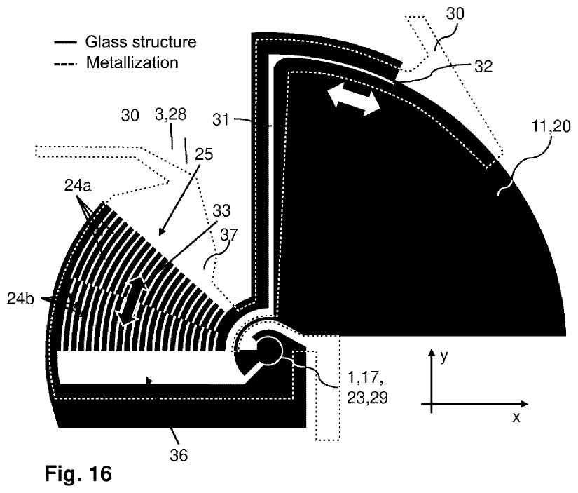

The comb structure 25 of FIG. 16 resulting herefrom, which realizes an electrostatic rotary drive/actuator 33, comprises a static anchor 37 that forms a plurality of static first fingers 24a and a second movably mounted anchor 36 that forms a plurality of movable second fingers 24b. In this case, the movable second fingers 24b are arranged in the respective interspaces between the static first fingers 24a. The fingers 24a, 24b thus form an interdigital structure. In this case, the movable fingers 24b/the anchor 36 are/is mounted on the glass substrate 3 by way of a micromechanical spring element 29 (illustrated in detail in FIG. 7). The spring element 29 forms a spiral spring that allows a rotation of the fingers 24b/the anchor 36 about a point of rotation located at the center of the spiral. As a result, an arm 31, which carries an end piece 32, can be rotated with the aid of the electrostatic actuator 33. To this end, the arm 31 and the anchor 36 are connected for conjoint rotation (the arm 31 and the anchor 36 have a monolithic embodiment). For example, the end piece 32 could be configured as an optical mirror for deflecting light, or as an electromechanical switch, for example. However, the comb structure 25 shown in FIG. 16 could also be used as part of a pressure sensor, for example if the movement of the arm 31 is damped to a greater or lesser extent at different air pressures, which could then be evaluated by sensors.

It is understood that a micromechanical comb structure 25 as shown in FIG. 16 could naturally also be used as an electrostatic sensor, for instance in order to electrically detect and measure a rotational movement of the arm 31. This is because a movement of the arm and the resultant movement of the fingers 24b lead to a change in the capacitance of the interdigital structure of the comb structure 25, which can be evaluated electrically. Moreover, electrostatic linear drives or stepper actuators can also be realized with a comb structure 25 according to the invention.

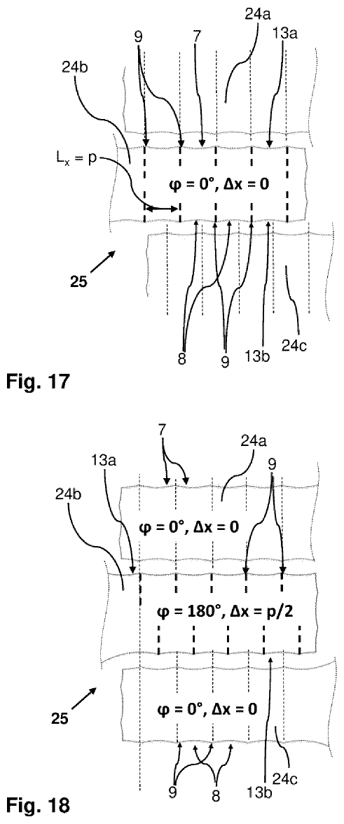

FIGS. 17 and 18 illustrate how sidewall scalloping, i.e. the indentations 8 in the sidewalls 13 of the fingers 24, can be set in a targeted manner in order to enable an actuation that is as uniform as possible. In both cases, the respective spatial phase angle φ(x) of the opposing ribs 9 in sidewalls 13a, 13b of the middle movable finger 24b in the comb structure 25 is chosen such that, in the shown current actuation position, those ribs 9 that are formed in sidewalls 13a, 13b of the middle finger 24b are formed flush on the top side (in the drawing) with corresponding ribs 9 of the first directly adjacent static finger 24a and formed with an offset to corresponding ribs 9 of the second directly adjacent static finger 24c on the opposite lower side. Should the respective middle finger 24b have moved to the right by half a length Lₓ/2 between two ribs 9, the situation is reversed because the offset in that case is to the ribs of the finger 24a while the lower ribs 9 are aligned with the ribs 9 of the finger 24c.

By contrast, should a stepwise actuation be sought after, the ribs of the respective finger can in each case be flush with ribs of a respective directly adjacent finger in a certain actuation position. Moreover, particularly pronounced sidewall scalloping might be advantageous in that situation in order to enable the desired nonlinear actuation.

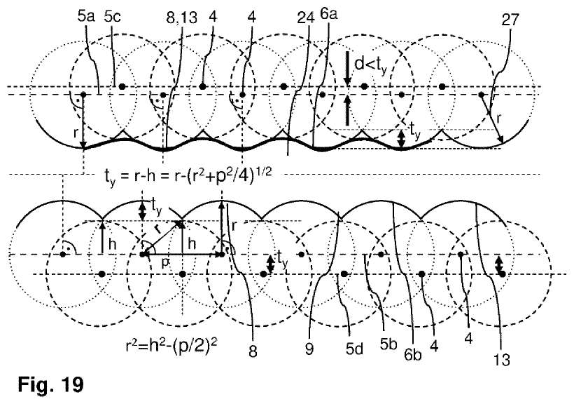

To illustrate the invention, reference is made at the end to FIG. 19 which, in the upper half, shows a configuration of a finger 24 of a comb structure 25 that deviates from previous examples according to the invention: As evident, the upper contour 6a, which approximately follows the wavy profile highlighted in bold, is defined by laser pulses 4 of two tool trajectories 5a and 5c, it only being the laser pulses 4 of the tool trajectory 5a that exhibit a maximal distance of r (=etching radius 27) from the concave indentations 8 in the sidewall 13 of the finger 24, while the distance between the indentations 8 and the laser pulses 4 of the tool trajectory 5c is slightly greater than the etching radius 27. By contrast, the lower contour 6b shows the limit case: The laser pulses 4 on the lowermost tool trajectory 5d serve to expose the interspace between the fingers 24; however, they do not define the contour 6b since they were placed at a minimum distance of t_{y}=r−(r²+p²/4)^{1/2} (=lateral depth of the indentations 8, which arises geometrically from the pulse spacing p and the etching radius r) from the tool trajectory 5b. Hence, the lower contour 6b, as proposed by the invention, is defined exclusively by the laser pulses 4 of the tool trajectory 5b, which was placed in each case at the distance r from the concave indentations 8 of the lower contour 6b. All laser pulses 4 that determine the lower contour 6b in the shown portion are thus located on a single continuous tool trajectory 5b. Accordingly, it is also only the lower contour 6b that exhibits characteristic sidewall scalloping with convex (and pointed) ribs 9 between the indentations 8.

Below, a few exemplary design and process parameters of fingers 24, designed according to the invention, of a comb structure 25 are listed in tables for different substrate thicknesses and substrate materials, as follows:

A) Examples of Fingers According to the Invention with Little Sidewall Scalloping

TABLE 1
Substrate material: Mempax/BF33

| Substrate thickness | | | | | |
|---|---|---|---|---|---|
| [μm] | 500 | 400 | 300 | 200 | 100 |
| Etching diameter (D = | 25 | 20 | 20 | 15 | 15 |
| 2r) [μm] | | | | | |
| Pulse spacing | 3 | 3 | 3 | 3 | 3 |
| (p) [μm] | | | | | |
| Finger width (B) [μm] | 10 | 10 | 10 | 10 | 10 |
| Scalloping depth (t_{y}) | 0.09 | 0.11 | 0.11 | 0.15 | 0.15 |
| [μm] | | | | | |
| Taper (ϕ) [°] | 1.5 | 1.5 | 1.5 | 1.5 | 1.5 |
| p/r | 0.24 | 0.3 | 0.3 | 0.4 | 0.40 |
| ty/r | 0.0072 | 0.0113 | 0.0113 | 0.0202 | 0.02 |
| ty/B | 0.0090 | 0.0113 | 0.0113 | 0.0152 | 0.02 |
| p/B | 0.3 | 0.3 | 0.3 | 0.3 | 0.3 |

TABLE 2
Substrate material: AF32 (= Glass substrate with a low coefficient
of thermal expansion, which is similar to that of a silicon wafer)

| Substrate thickness | | | | | |
|---|---|---|---|---|---|
| [μm] | 500 | 400 | 300 | 200 | 100 |
| Etching diameter | 65 | 55 | 40 | 30 | 20 |
| (D = 2r)[μm] | | | | | |
| Pulse spacing | 5 | 5 | 5 | 5 | 5 |
| (p)[μm] | | | | | |
| Finger width (B)[μm] | 10 | 10 | 10 | 10 | 10 |
| Scalloping depth | 0.1 | 0.11 | 0.16 | 0.21 | 0.32 |
| (t_{y}) [μm] | | | | | |
| Taper(ϕ)[°] | 6 | 6 | 6 | 6 | 6 |
| p/r | 0.15385 | 0.1818 | 0.25 | 0.333 | 0.50 |
| ty/r | 0.00296 | 0.0041 | 0.0078 | 0.0140 | 0.03 |
| ty/B | 0.00963 | 0.0114 | 0.0156 | 0.0210 | 0.03 |
| p/B | 0.5 | 0.5 | 0.5 | 0.5 | 0.5 |

TABLE 3
Substrate material: Fused silica

| Substrate thickness | |
|---|---|
| [μm] | 500 |
| Etching diameter (D = 2r) [μm] | 20 |
| Pulse spacing (p) [μm] | 5 |
| Finger width (B) [μm] | 10 |
| Scalloping depth (t_{y}) [μm] | 0.32 |
| Taper (ϕ) [°] | 0.5 |
| p/r | 0.5 |
| ty/r | 0.03 |
| ty/B | 0.03 |
| p/B | 0.5 |

B) Examples of Fingers According to the Invention with Pronounced Sidewall Scalloping

TABLE 4
Substrate material: Mempax/BF33

| Substrate thickness | | | | | |
|---|---|---|---|---|---|
| [μm] | 500 | 400 | 300 | 200 | 100 |
| Etching diameter (D = 2r) [μm] | 25 | 20 | 20 | 15 | 15 |
| Pulse spacing (p) [μm] | 10 | 10 | 10 | 10 | 10 |
| Finger width (B) [μm] | 10 | 10 | 10 | 10 | 10 |
| Scalloping depth (t_{y}) [μm] | 1.04 | 1.34 | 1.34 | 1.91 | 1.91 |
| Taper (ϕ) [°] | 1.5 | 1.5 | 1.5 | 1.5 | 1.5 |
| p/r | 0.80 | 1.00 | 1.00 | 1.33 | 1.33 |
| ty/r | 0.08 | 0.13 | 0.13 | 0.25 | 0.25 |
| ty/B | 0.10 | 0.13 | 0.13 | 0.19 | 0.19 |
| Tp/B | 1 | 1 | 1 | 1 | 1 |

TABLE 5
Substrate material: AF32 (= Glass substrate with a low coefficient
of thermal expansion, which is similar to that of a silicon wafer)

| Substrate thickness | | | | | |
|---|---|---|---|---|---|
| [μm] | 500 | 400 | 300 | 200 | 100 |
| Etching diameter (D = 2r) [μm] | 65 | 55 | 40 | 30 | 20 |
| Pulse spacing (p) [μm] | 15 | 15 | 15 | 15 | 15 |
| Finger width (B) [μm] | 10 | 10 | 10 | 10 | 10 |
| Scalloping depth (t_{y}) [μm] | 0.88 | 1.04 | 1.46 | 2.01 | 3.39 |
| Taper (ϕ) [°] | 6 | 6 | 6 | 6 | 6 |
| p/r | 0.46 | 0.55 | 0.75 | 1.00 | 1.50 |
| ty/r | 0.03 | 0.04 | 0.07 | 0.13 | 0.34 |
| ty/B | 0.09 | 0.10 | 0.15 | 0.20 | 0.34 |
| p/B | 1.5 | 1.5 | 1.5 | 1.5 | 1.5 |

TABLE 6
Substrate material: Fused silica

| Substrate thickness | |
|---|---|
| [μm] | 500 |
| Etching diameter (D = 2r) [μm] | 20 |
| Pulse spacing (p) [μm] | 5 |
| Finger width (B) [μm] | 10 |
| Scalloping depth (t_{y}) [μm] | 0.32 |
| Taper (ϕ) [°] | 0.5 |
| p/r | 0.5 |
| ty/r | 0.03 |
| ty/B | 0.03 |
| p/B | 0.5 |

As evident from the numerical values, the etching diameters D=2r of these examples are in the order of a few μm, wherein the following may typically apply: r≤50 μm or even r≤20 μm or even r≤10 μm. Typically at least the following applies to the ratio of etching diameter D=2r to substrate thickness t: D/t≤1:5=0.2; in the event of a very large substrate thickness (t≥400 μm), the following may even apply: D/t≤1:20=0.05. In this case, the specified taper angle ϕ 22 describes the inclination of the sidewall faces 13 of the fingers 24 with respect to the z-axis (=surface normal 26 of the substrate 3)—in this respect, see FIGS. 11-13.

In the example of table 6, an aspect ratio (=substrate thickness/spring width) of the finger 24 of 100 is obtained. In this case, sidewall scalloping is still very weakly pronounced, with a ratio t_{y}/r=0.03. This shows that LIDE can be used to manufacture very homogenous fingers 24 with an enormous aspect ratio; these are ideally suited to micromechanical comb structures 25. In the examples of table 4, the extent of sidewall scalloping increases with decreasing substrate thickness. For instance, the following applies in the event of a substrate thickness of 100 μm: t_{y}/B=19% and t_{y}/r>20%. For the same substrate thickness of 100 μm, the ratio of lateral depth t_{y} of the indentation 8 to maximum width B 15 of the finger 24 is even 34% in table 5. Accordingly, clear indentations 8 or ribs 9 are formed in the sidewalls 13 of the microstructure 1 in these examples. Such fingers 24 would be suitable for use in a stepper actuator.

In summary, in order to extend the possible applications of the already known LIDE (laser-induced deep etching) method, this invention proposes, in the production of a micromechanical comb structure 25 by placing a plurality of laser pulses 4 on a glass substrate 3 with a subsequent wet-chemical etching step for exposing the comb structure 25, to precisely control the position of the laser pulses 4 that define the outer contour 6 of respective fingers 24 of the comb structure 25. This makes it possible to form very narrow fingers 24 that have uniform sidewalls 13, and so very small gap dimensions 35 and uniform electrostatic actuation of the comb structure 25 are rendered possible. By controlling the phase angle φ and/or the extent of the sidewall scalloping of the fingers 24, it is also possible to favorably influence or set, in a targeted manner, the mechanical properties (cf. FIG. 9).

### LIST OF REFERENCE SIGNS

1 Microstructure, in particular bending structure
2 Direction of extent (of 1)
3 Glass substrate
4 Laser pulse (the point of incidence on 3 defines a laser point with xy-coordinates on the surface of 3)
5 Tool trajectory (along which the laser head is guided and on which the laser pulses are placed)
6 Contour (of 1, in particular the outer boundary of 1 in the substrate surface/on the top side of 1)
7 Etching profile (in the xy-plane, caused by 4)
8 (Concave) indentation (in the sidewall of 24)
9 (Convex) rib (in the sidewall of 24)
10 Tool trajectory spacing (or local y-distance between 4)
11 Modified regions (in 3)
12 Deflection region (of 1)
13 Sidewall or sidewall face (of 1)
14 Lateral depth (of 14)
15 (Maximum) width (of 1 transversely to 2)
16 Cantilever
17 Flexure
18 Laser pulse pair
19 Center axis or centerline (of 1)
20 Region etched free (using wet chemistry)
21 Central plane (of 3)
22 Taper angle ϕ
23 Bending structure (for example configured as a micromechanical spring element)
24 Movable finger (of 25)
25 Micromechanical comb structure
26 Surface normal (of 3=z-axis)
27 Etching radius
28 Substrate plane (of 3=xy-plane)
29 Micromechanical spring element
30 Metallization (of 13 in particular)
31 Moving arm
32 End piece (of 31 actuated by 25)
33 Electrostatic actuation/electrostatic actuator
34 Interior angle (of 13)
35 Gap dimension
36 Movable anchor
37 Static anchor

1. A micromechanical comb structure (25) made of glass, comprising:
a glass substrate having a plurality of micromechanical fingers (24), the comb structure (25) being deflectable in a substrate plane (28) defined by the glass substrate (3), and
the fingers (24) made of the glass substrate (3) being exposed by laser-induced modification of the glass substrate (3) and subsequent wet-chemical anisotropic etching,
in which laser pulses (4) that define an outer contour (6) of the fingers (24) are placed on respective continuous tool trajectories (5a, 5b) that are opposite each other and
each of the tool trajectories (5a, 5b) has a maximum distance r from the contour (6), the distance corresponding precisely to an etching radius (27) of a wet-chemical etching step used to expose the fingers (24).

2. The micromechanical comb structure (25) made of glass as claimed in claim 1, wherein at least one flexure (17) is exposed by the laser-induced modification of the glass substrate (3) and the subsequent wet-chemical anisotropic etching, said flexure being used to monolithically connect the comb structure (25) to the glass substrate (3) in order to provide a deflection capability.

3. The micromechanical comb structure (25) made of glass as claimed in claim 1, wherein the fingers (24) each have two sidewalls (13a, 13b) that are opposite each other and exhibit concave indentations (8),
said concave indentations (8) each exhibit a curvature defined by the etching radius r and are delimited by respective convex ribs (9), and
the indentations (8) exhibit a constant mean spacing Lₓ, at least in sections of a length of the respective finger (24).

4. The micromechanical comb structure (25) made of glass as claimed in claim 1, wherein opposing ribs (9), which are formed in opposing sidewalls (13a, 13b/13c, 13) of a respective one of the fingers (24) exhibit an offset Δx along a direction of extent (2) of the finger (24), to which the following applies: Lₓ/4≤Δx≤Lₓ/2, where Lₓ is the mean spacing between two directly adjacent ones of the ribs (9) that are formed in a same one of the sidewalls (13a/13b).

5. The micromechanical comb structure (25) made of glass as claimed in claim 1, wherein in order to obtain weakly pronounced sidewall scalloping, the laser pulses (4) are placed in such a way and the fingers (24) are etched free in such a way that: p<r, where p=a ratio of a mean pulse spacing between adjacent laser pulses (4) on one of the two tool trajectories (5a or 5b) and r=the etching radius (27).

6. The micromechanical comb structure (25) made of glass as claimed in claim 1, wherein; t_{y}/r<0.1, where r=the local etching radius (27) and t_{y}=a lateral depth (14) of the respective indentations (8), and t_{y}/B<0.1, where B=
maximal width (15) of the respective finger (24) transversely to a direction of extent (2) thereof.

7. The micromechanical comb structure (25) made of glass as claimed in claim 1, wherein the fingers (24) exhibit a rhombic cross section that results from wet-chemical etching of the glass substrate (3) on both sides.

8. The micromechanical comb structure (25) made of glass as claimed in claim 1, wherein side faces (13) of the fingers (24) form a respective taper angle ϕ (22) of less than 6°.

9. The micromechanical comb structure (25) made of glass as claimed in claim 1, wherein p/B<0.5, where p=a pulse spacing between two adjacent laser pulses (4) on a tool trajectory (5) extending parallel to the respective contour (6) of the respective finger (24) and B=a maximum width (15) of the respective finger (24) transversely to a direction of extent (2) thereof, and
the maximum width B (15) of the respective finger (24) is less than 100 μm.

10. The micromechanical comb structure (25) made of glass as claimed in claim 1, wherein sidewalls (13) of the fingers (24) have a metallization (30) that serves for the formation of electrodes of the fingers (24).

11. The micromechanical comb structure (25) made of glass as claimed in claim 1, wherein a respective spatial phase angle φ(x) of respective laser pulse pairs (18) of thee laser pulses or opposing ribs (9) in sidewalls (13a, 13b) of one of the fingers (24b) along a respective direction of extent (2) of the finger (24b) is chosen such that
in a specific actuation position of the comb structure (25), the ribs (9) formed in sidewalls (13a, 13b) of the finger (24b)
are formed flush with corresponding ones of the ribs (9) of a first directly adjacent one of the fingers (24a) on one side and
are formed offset to corresponding ones of the ribs (9) of a second directly adjacent one of the fingers (24c) on an opposite side, and
opposing ribs (9) of the finger (24b) located between the first and second directly adjacent fingers (24a, 24c) exhibit an offset Δx<Lₓ/4, where Lₓ is a mean spacing between two directly adjacent ones of the ribs.

12. A micromechanical actuator comprising the micromechanical comb structure (25) as claimed in claim 1,
wherein the fingers (24) of the comb structure (25) comprise sidewall electrodes for electrostatic actuation of the comb structure (25).

13. A micromechanical stepper actuator comprising the micromechanical comb structure (25) made of glass as claimed in claim 1, wherein
a step size (G) of the stepper actuator corresponds to a spacing (Lₓ) of convex ribs (9) (Lₓ=G) which delimit lateral concave indentations (8) that are formed in sidewalls (13) of the fingers (24) and exhibit a curvature defined by the etching radius (27), and t/r>0.1, where r=the etching radius (27) and t_{y}=a lateral depth (14) of the respective indentations (8).

14. The stepper actuator as claimed in claim 13,
wherein a respective spatial phase angle φ(x) of respective laser point pairs (18) or lateral indentations (8) along a respective direction of extent (2) of directly adjacent ones of the fingers (24) of the comb structure (25) is φ=0°+/−60°,
such that ribs (9) formed in opposing sidewalls (13) of in each case two directly adjacent ones of the fingers (24) are at least approximately flush with each other in a specific actuation position of the comb structure (25).

15. A method for producing a micromechanical comb structure (25) made of glass, wherein the comb structure (25) comprises a glass substrate (3) with a plurality of micromechanical fingers (24), and the comb structure (25) is deflectable in a substrate plane (28) defined by the glass substrate (3), the method comprising:
placing laser pulses (4) that are intended to define an outer contour (6) of the fingers (24) on respective continuous tool trajectories (5a, 5b) that are opposite each other in order to expose the fingers, and
wet-chemical etching all of the fingers (24) of the comb structure (25) in a common wet-chemical etching step such that a respective outer contour (6) of the fingers (24) is exposed that has a maximum distance (r) from the associated tool trajectory (5a, 5b) that corresponds to an etching radius (27) of the etching step.

16. The method as claimed in claim 15,
wherein an anisotropy of the etching step is chosen such that the fingers (24) are formed with a taper angle ϕ (22) of no more than 6° with respect to a surface normal (26) of the substrate plane (28), and
choosing a ratio of a first etching rate of regions (11) of the glass substrate (3) modified by laser radiation and a second etching rate of unmodified regions of the glass substrate (3) is chosen to be greater than 15:1.

17. The method as claimed in claim 15, further comprising forming the fingers (24) with a rhombic cross-sectional shape by a wet-chemical etching solution being used to perform the etching from two sides of the glass substrate (3), and
wherein the anisotropy of the etching step is set such that following the etching, the fingers (24) form an interior angle (34) with a respective sidewall (13) of at least 170°.

18. The method as claimed in claim 15, further comprising,
in order to obtain weakly pronounced sidewall scalloping, placing the laser pulses (4) such and the fingers (24) are etched free in such a way that the following applies: p<r, where p=a mean pulse spacing between adjacently placed ones of the laser pulses (4) and r=the etching radius r.

19. The method as claimed in claim 15, wherein a respective contour (6) of the fingers (24) exhibits lateral concave indentations (8) that each exhibit a curvature defined by the etching radius (r) at a surface of the glass substrate (3) and that are delimited by respective convex ribs (9), and t_{y}/r<0.1, where
r=the local etching radius (27) and t_{y}=a lateral depth (14) of the respective indentations (8), and
t_{y}/B<0.1, where B=a maximal width (15) of the respective finger (24) transversely to a direction of extent (2) thereof.

20. The method as claimed in claim 15, further comprising applying a metallization (30) serving to form electrodes of the fingers (24) using
a shadow mask or
a spray photoresist or
a dry photoresist laminated
as a masking layer on sidewalls (13) of the fingers (24).

21. A portable electronic device, comprising the micromechanical comb structure (25) made of glass as claimed in claim 1,
wherein the fingers (24) of the comb structure (25) have a respective length of >100 μm.
